(19) United States
(12) Patent Application Publication
(10) Pub. No.: US 2004/0123743 A1
(43) Pub. Date: Jul. 1, 2004

(54) Water cooled cookig range

(76) Inventor: Yuk Yiu Wong, Brislington (GB)

Correspondence Address: WELSH & KATZ, LTD, 120 S RIVERSIDE PLAZA, 22ND FLOOR, CHICAGO, IL, 60606, US

(21) Appl. No.: 10/664,428

(22) Filed: Sep. 5, 2003

(30) Foreign Application Priority Data
Sep. 18, 2002 (GB) 02217040.0
Sep. 18, 2002 (GB) 0221705.7

(51) Int. Cl. A47J 37/10

(52) U.S. Cl. 99/352; 99/422

(57) ABSTRACT

A water cooled cooking range (2) comprising a cooking surface area (4), a water supply arranged to provide a constant supply of water onto said cooking surface area (4), an exit (8) for the water from said cooking surface area (4) and a chamber area (10), located lower than said cooking surface area (4), to receive the water from said cooking surface area exit (8), the chamber (10) having means for separating hydrophobic waste material from water.

The present invention relates to a water cooled cooking range having means for separating hydrophobic waste material from water.

Traditional water cooled cooking ranges have water running continuously onto the cooking surface area which helps to dispel the heat and wash away any food and grease spillage down the drains. Unfortunately, grease spillage, which can rarely be avoided, can cause drains to become blocked. This is not good for the premises or the environment and in addition, new health and safety regulations have made it an offence to pour grease or fat into the soil drain.

A further problem with traditional cooking ranges is the limited access to the underside of the range beneath the cooking surface area. To service or clean the range it is necessary to remove the front fascia panel in order to gain access to the serviceable parts such as the burners or the gas valve. This can be very awkward and consequently the range may need to be taken apart to be cleaned. It also means that many ranges are not properly cleaned and grease and debris can build up inside the range which poses an obvious health risk.

The present invention seeks to alleviate or reduce the above limitations.

According to the present invention there is provided a water cooled cooking range comprising:

a cooking surface area;

a water supply arranged to provide a constant supply of water onto said cooking surface area;

an exit for the water from said cooking surface area; and

a chamber area located lower than said cooking surface area to receive the water from said cooking surface area exit, the chamber having means for separating hydrophobic waste material from water.

Preferably the means for separating hydrophobic waste material comprises the interior of the chamber being divided into two regions by a dividing wall which extends from a first point above but relatively close to the bottom surface of the chamber to a second point on a wall of the chamber, the exit for water from the cooking surface area being provided in the first region and a waste outlet being provided in the second region above the level of the bottom of the dividing wall, the two regions being in communication with one another along the bottom surface.

Having the dividing wall extend to a point just above the bottom surface improves the separation capabilities of the chamber. The amount of hydrophobic waste material which enters the second region is limited since initially relatively clean water will normally enter the chamber first and will fill the bottom layer of the second region up to the bottom of the dividing wall. Any hydrophobic material which subsequently enters the chamber will form a layer on top of the water in the first region.

Preferably, the means for separating the hydrophobic waste material from the water further comprises a collection tray located in the first region above the level of the waste outlet. The collection tray may suitably be formed from a portion of the dividing wall. The means for separating the hydrophobic waste material from the water may suitably further comprise a removable cartridge filter adapted to fit the collection tray. More preferably, the removable cartridge filter is provided with handles which facilitate removal from the collection tray.

Whilst the chamber may be located to the side or behind the cooking range it is preferred that the chamber is located beneath the cooking surface area.

Advantageously, a waste filter tray may be provided in the first region beneath the drain plug to filter out solid waste particles from the mixture of water and hydrophobic waste material as it enters the chamber.

Preferably, a drain valve is provided in the bottom surface of the first region of the chamber. This enables the chamber to be completely drained when the cooking range is not in use.

The dividing wall may preferably be inclined at an angle such that the cross section of the second region of the chamber is wider at the top than at the bottom. Most preferably the dividing wall is inclined at an angle of approximately 45°.

It is preferred that the water cooled cooking range is a gas cooking range and even more preferred that it is a water cooled gas wok cooking range.

Whilst it is possible that the chamber area could be a separate component it is preferred that it is integral to the cooling range.

Advantageously, the water cooled cooking range further comprises a cooking range body, wherein the cooking surface area is movable relative to the cooking range body.

Having the cooking surface area movable relative to the range body enables users to gain easier access to the area under the cooking surface area and allows the cooking range to be more easily cleaned. Food debris and grease which gets into the area under the cooking surface area can build up on the burners and other parts. This improved access makes daily cleaning much easier and also facilitates the maintenance of the serviceable part which reduces service time and costs.

It is preferred that attachment means are provided to attach a portion of the cooking surface area to the cooking range body. The attachment means preferably comprises a pivot point and even more preferably the attachment means comprises a hinged portion. When this is the case it is preferred that at least two hinges are provided at locations spaced apart along an edge of the cooking surface area. Preferably the edge opposite the point where a user will stand has the hinged attachment. This enables a user to lift the cooking surface area upwards in order to gain access to the area under the cooking surface area. It will be necessary to drain the cooking surface area of any water before it is lifted.

The edge opposite the hinged edge is preferably is provided with means for releasably connecting said cooking surface area to said cooking range body. This means may be in the form of a lockable latch. This feature enables the cooking surface area to be securely held in place when the cooking range is in use.

In a conventional commercial cooking range the cooking surface area may w igh up to 90 kg. It would ther fore be difficult for a single user to lift the cooling surface area. It is preferred that means is provided for moving the cooking surface area from a first position to a second position. The means may conveniently comprise a gas spring lifting mechanism. The first position referred to is the position in which the cooking surface area is substantially parallel to a floor surface on which the cooking range stands for use. The second position is the open position in which the cooking surface area pivots about the hinges such that the serviceable parts underneath the cooking surface area may be accessed. Preferably, the cooking surface area pivots through between 45° and 90°.

The water cooled cooking range may be a gas cooking range and it may be a wok cooking range. The chamber area is preferably located within the cooking range body.

For a better understanding of the present invention reference will now be made to the accompanying drawings showing, solely by way of example, an embodiment of the present invention in which:

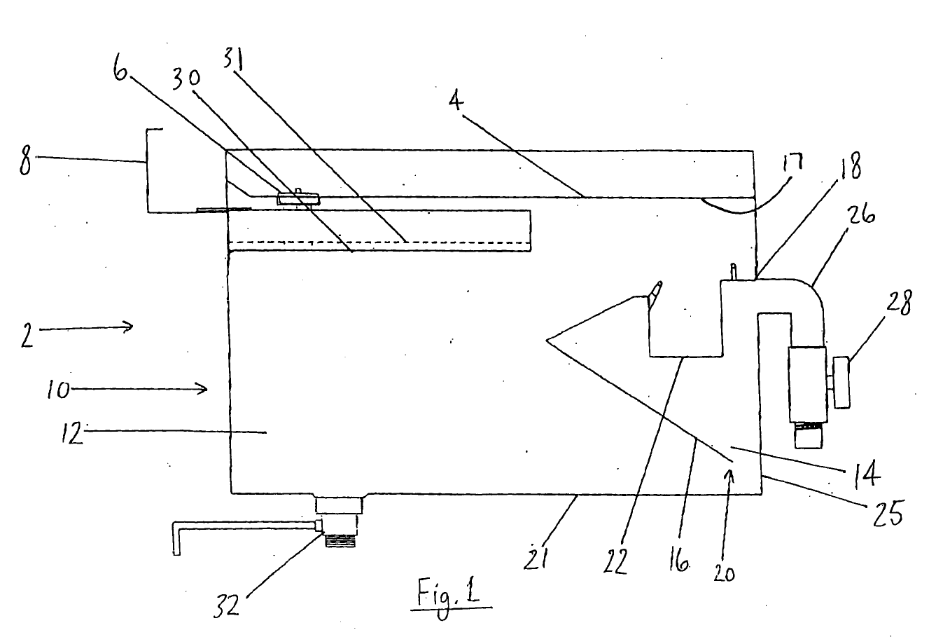

FIG. 1 shows a side sectional view of portion of a water cooled gas wok cooking range;

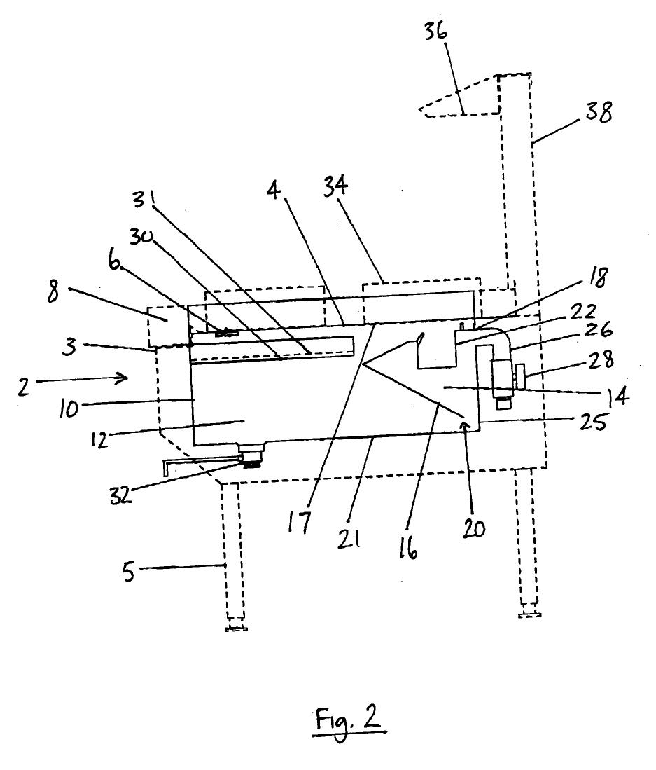

FIG. 2 shows a side sectional view of a water cooled cooking range with the cooking surface area in a first, or closed, position; and

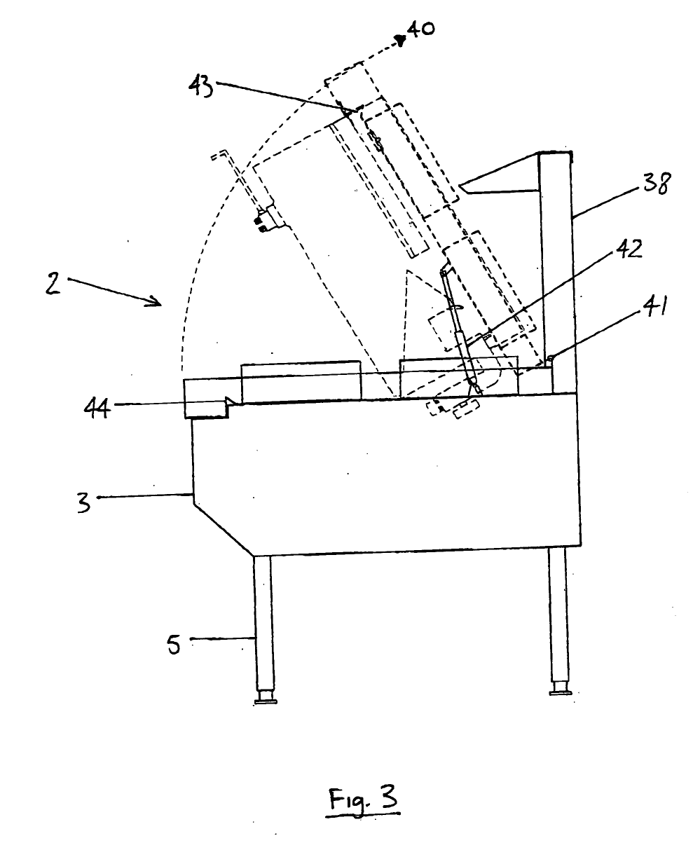

FIG. 3 shows a side sectional view of a water cooled cooking range with the cooking surface area in a second, or open, position.

Referring firstly to FIG. 1, the water cooled gas wok cooking range 2 is formed from heavy gauge high-grade stainless steel with highly polished surfaces for easy cleaning.

The range 2 has a cooking surface area 4 with a plurality of raised cooking rings (not shown) and a drain with a plug 6. The cooling surface area 4 and cooking rings are formed by being pressed out on a 200 ton CNC hydronic power press, which produces the required shaped structure without needing welded joints. The cooking range 2 is also provided with a water supply (not shown) which provides a constant supply of cold water for the cooking surface area 4 around the rings whilst the cooking range 2 is in use. For wok cooking in particular, it is necessary to have the cooking rings at high temperatures. In order to dissipate some of the heat generated the water cooled cooking rang 2 has water running continuously onto the cooking surface area 4 surrounding the cooking rings. Not only does this help to dispel the heat but it also helps to wash away any food and grease spilt onto the cooking surface area 4.

The cooking range 2 is provided with a font drain gully 8 which receives an overflow of water from the cooking surface area 4. The front drain gully 8 directs the overflow into a chamber 10 located beneath the cooking surface area 4. The cooking surface area 4 is also in communication with the chamber 10 via the drain when the plug 6 is removed to enable complete draining of water from the cooking surface area 4 after use.

The interior of the chamber 10 is divided into two regions 12, 14 by a dividing wall 16. The dividing wall 16 is also made from heavy gauge high-grade stainless steel and extends from a first position 18 on the back wall of the chamber 10 below the top surface 17 to a second position 20 just above the bottom surface 21 of the chamber 10. Ea addition to dividing the chamber 10 into two regions 12,14 the dividing wall 16 also forms a collection tray 22 in the first region 12. The collection tray 22 is in the form of a rectangular trough and in use a removable cartridge filter (not shown) will be placed in the tray 22. The removable cartridge filter would have a handle to facilitate its removal from the tray 22 in order to dispose of the hydrophobic waste material which has been collected.

A first portion of the dividing wall 16 is inclined upwards at an angle of approximately 45° from the bottom back corner of the chamber 10. A second portion of the dividing wall 16 incorporates the collection tray 22 and is physically attached to the chamber 10 at a point just below the top surface 17. This configuration means that the cross sectional area of the second region 14 is smaller at the bottom than it is at the top. Consequently, it only takes a small amount of water to fill the bottom of the second region 14.

The first region 12 and the second region 14 are in communication with one another at a position adjacent the bottom surface 21. The drain plug 6 is located in the top surface 17 of the first region 12 of the chamber 10 and a waste outlet 26 is provided in the second region 14, located wall 16. A portion of the waste outlet 26 is lower than the collection tray 22. The area of the waste outlet 26 which is lower than the collection tray 22 must be sufficiently large such that the water flow out of the second region 14 of the chamber 10 is sufficient to ensure that the water within the chamber 10 does not overflow into the collection tray 22. The portion of the waste outlet 26 which is below the level of the collection tray 22 must therefore be capable of permitting flow equal to that of the flow from the water supply, in normal use, such that equilibrium is attained. The waste outlet 26 is also provided with a valve 28.

A waste filter tray 30 is provided in the first region 12 directly beneath the drain plug 6. The waste filter tray 30 is made of the same stainless steel as the cooking range 2 and has apertures to allow the flow of water into the chamber 10. The waste filter tray 30 has a filter 31 and is provided to filter out solid waste particles from the water/hydrophobic waste material as it enters the chamber 10.

A main drain valve 32 is provided in the bottom surface 21 of the first region 12. This enables the chamber 10 to be completely emptied of water when not in use, thus allowing the chamber 10 to be thoroughly cleaned.

Referring now to FIGS. 2 and 3. FIG. 2 shows a more complete view of a cooking range 2. The cooking range 2 has a body 3 supported by legs 5 which rest on a floor surface. The body 3 supports cooking surface area 4 which has a plurality of raised cooking rings 34 and a drain with a plug 6. The cooking surface area 4 rests on top of the body 3 such that, in use, it is substantially parallel with the floor surface. The cooking surface area 4 is actually inclined slightly with respect to the floor surface. The incline is such that the flow of water is directed towards the cooking surface area drain in order that the cooking surface area 4 may be completely drained.

A back plate 38 extends perpendicular to the cooking surface area 4 along the length of the body 3 and supports a spice shelf 36.

The cooking range 2 is provided with a front drain gully 8 which receives an overflow of water from the cooking surface area 4. The front drain gully 8 directs the overflow into a chamber 10 located beneath the cooking surface area 4. The cooking surface area 4 is also in communication with the chamber 10 via the drain when the plug 6 is removed to enable complete draining of water from the cooking surface area 4 after use.

Referring now to FIG. 3, this shows the cooking range 2 of FIG. 2 in which the cooking surface area 4 has been moved from the first position to the second position along the path indicated by the arrow 40. The cooking surface area 4 is attached to the body 3 at the rear, adjacent the back plate 38. The attachments are in the form of hinges 41 which enable the cooking surface area 4 to be moved from a first, or closed, position in which it is perpendicular to the back plate 38 and substantially parallel to the floor surface to a second, or open, position in which the front edge of the cooking surface area 4 is lifted such that the cooking surface area 4 pivots about the hinges 41. This enables the user to gain access to the serviceable parts under the cooking surface area 4.

Since the cooking surface area 4 in a commercial cooking range can weigh up to 90 kg a gas pressured spring lifting mechanism 42 is provided to lift the cooking surface area 4. One preferred gas pressured spring 42 is that made by. Eckold. The gas pressured spring 42 should be selected taking into account the weight of the cooking surface area 4.

Locking latches 43 are provided in the front inside edge of the cooking surface area 4. These latches 43 engage with corresponding portions 44 on the body 3 and ensure that the cooking surface area 4 remains in the first position when in use. In order to move the cooking surface area 4 from the first position to the second position the latches 43 are released and the gas pressured spring 42 lifts the cooking surface area 4.

The method of separating hydrophobic waste from water in the water cooled cooking range will now be described with reference to FIG. 1. When the cooking range 2 is in use there is a constant flow of water onto the cooling surface area 4 around the cooking rings. This water helps to dissipate some of the heat generated in the cooking rings and also to wash away any food debris grease and, when a certain level is reached, the water overflows the cooking surface area into the front drain gully 8. The water (and any hydrophobic waste material, such as cooking oil, which has spilt onto the cooking surface area 4) then flows along the front drain gully 8 and into the chamber 10 through the waste filter tray 30. This filters out any solid particles, such as food debris, which may have been spilt on the cooking surface area 4.

The water/hydrophobic waste material enters the chamber 10 in the first region 12. Since the water flows constantly through the system the first water to enter the chamber will be largely free of any contaminants since little cooking will have been done. The water will flow into the second region 14 along the bottom of the chamber 10 and the water level will begin to rise. As cooking commences any hydrophobic material, such as cooking oil, will pass through the system and form a layer on top of the water layer. Since the gap between the bottom of the dividing wall 16 and the bottom of the chamber 10 is relatively small substantially none of the hydrophobic material will enter the second region 14. When the water in the second region 14 reaches the level of the waste outlet 26 it will flow out of the chamber 10 and into the soil drain. Equilibrium will be established between the flow of water/hydrophobic material into the chamber and the flow of water out.

The layer of hydrophobic waste material on top of the water layer will gradually increase as cooking proceeds. When it is desired to remove the hydrophobic waste material from the range 2 the drain valve 28 on the waste outlet 26 is closed. This stops the flow of water out of the chamber 10. Consequently the level of water/hydrophobic waste material inside the chamber 10 will begin to rise above the equilibrium level. Eventually, the level of the hydrophobic waste material will become so great that it will overflow into the collection tray 22. When all the hydrophobic waste material has overflown into the collection tray 22 the drain valve 28 is reopened and the equilibrium will be re-established. The collection tray 22 may suitably be provided with a removable cartridge which can be removed from the collection tray 22 to enable the hydrophobic waste to be safely disposed of. This operation can be carried out whilst cooking continues. When cooking has finished the drain plug 6 on the cooking surface 4 can be removed in order to drain the cooking surface area 4. The cooking surface 4 can then be washed down with water and the separation process repeated.

1. A water cooled cooking range comprising:
a cooking surface area;
a water supply arranged to provide a constant supply of water onto said cooking surface area;
an exit for the water from said cooking surface area; and
a chamber area located lower than said cooking surface area to receive the water from said cooking surface area exit, the chamber having means for separating hydrophobic waste material from water.

2. A water cooled cooking range according to claim 1, wherein the means for separating the hydrophobic waste material from water comprises the interior of the chamber being divided into two regions by a dividing wall which extends from a first point above but relatively close to the bottom surface of the chamber to a second point on a wall of the chamber, the exit for water from the cooking surface area being provided in the first region and a waste outlet being provided in the second region above the level of the bottom of the dividing wall, the two regions being in communication with one another along the bottom surface.

3. A water cooled cooking rage according to claim 2, wherein the waste outlet has a valve.

4. A water cooled cooking range according to claim 3, wherein the means for separating the hydrophobic waste material from water first comprises a collection tray located in the first region above the level of the waste outlet.

5. A water cooled cooking range according to claim 4, wherein the collection tray is formed from a portion of the dividing wall.

6. A water cooled cooking range according to claim 4, wherein the means for separating the hydrophobic waste material from the water further comprises are movable cartridge filter adapted to fit the collection tray.

7. A water cooled cooking range according to claim 6, wherein the removable cartridge filter is provided with a handle.

8. A water cooled cooking range according to claim 2, wherein a waste filter tray is provided in the first region beneath the drain plug to filter out solid waste particles from the mixture of water and hydrophobic waste material as it enters the chamber.

9. A water cooled cooking range according to claim 2, wherein a drain valve is provided in the bottom surface of the first region of the chamber.

10. A water cooled cooking range according to claims 2, wherein the dividing wall is inclined at an angle such that cross section of the second region is wider at the top than at the bottom.

11. A water cooled cooking range according to claim 1, wherein the chamber is located beneath the cooking surface area.

12. A water cooled cooking range according to claim 1, wherein the chamber area is integral with the cooking range.

13. A water cooled cooking range according to claim 1, further comprising a cooking range body, wherein the cooking surface area is movable relative to the cooking range body.

14. A water cooled cooking range according to claim 13, wherein attachment means are provided to attach a portion of the cooking surface area to the cooking range body.

15. A water cooled cooking range according to claim 14, wherein the attachment means comprise a hinged portion.

16. A water cooled cooking range according to claim. 15, wherein a hinge is provided at two locations along an edge of the cooking surface area.

17. A water cooled cooking range according to claim 16, wherein the opposing edge of the cooking surface area is provided with means for releasably connecting said cooking surface area to said cooking range body.

18. A water cooled cooking range according to claim 17, wherein the means comprises a lockable latch which engages with a portion of the cooking range body.

19. A water cooled cooking range according to claim 13, wherein means is provided for moving the cooking surface area from a first position to a second position.

20. A water cooled cooking range according to claim 19, wherein the means for moving the cooking surface area comprises a gas spring lifting mechanism.

21. A water cooled cooking range according to claim 13, wherein the chamber area is located within the cooking range body.

22. A method of separating hydrophobic waste material from water in a water cooled cooking range according to claim 4, comprising the steps of:
i) closing the valve on the waste outlet;
ii) maintaining the flow of water onto the cooking surface;
iii) monitoring the level of water/hydrophobic waste material in the chamber until the hydrophobic waste material overflows into the collection tray.
iv) reopening the valve on the outlet; and
v) removing the hydrophobic waste material.

23. A method according to claim 22 further comprising the step of removing the cooking surface drain plug.
